(19) United States
(12) Patent Application Publication
(10) Pub. No.: US 2012/0257393 A1
(43) Pub. Date: Oct. 11, 2012

(54) Light Fixture, Method for Displaying Light, and Light Fixture Housing

(75) Inventor: Daniel ZEISNER, Vienna (AT)

(73) Assignee: SCHONBEK WORLDWIDE LIGHTING INC., Plattsburgh, NY (US)

(21) Appl. No.: 13/084,202

(22) Filed: Apr. 11, 2011

(51) Int. Cl. F21V 5/00; F21V 7/00

(52) U.S. Cl. 362/297; 362/311.01

(57) ABSTRACT

Light fixtures, methods for displaying light, and light fixture housings having enhanced appearance and providing distinctive light patterns are provided. The light fixture includes a light source, and a housing mounted about the light source. The housing includes a body, for example, a transparent glass body, having an outer surface having a plurality of facets adapted to refract at least some light emitted by the light source; and an opening in the body to emit light. Dimensions of the housing body are defined to produce substantially uniform light patterns on surfaces adjacent the light fixture. Methods of displaying light and faceted light housings are also disclosed.

### BACKGROUND OF THE INVENTION

1. Field of the Invention

The present invention relates, generally, to light fixtures and methods of displaying light. In particular, the present invention relates to light fixtures having transparent housings with facetted outer surfaces that refract and/or reflect the light emitted by the light source within the housing.

2. Description of Related Art

Lighting designers continue to pursue the design and development of novel designs to enhance the appearance of light fixtures and make the light fixture more appealing to the customer while providing the desired illumination. However, it is not often the case that the illumination or the pattern of the illumination, produced by a light fixture is also novel. Aspects of the present invention provide light fixtures, methods of displaying light, and light fixture housings that not only provide visual appeal, but may also provide appealing light patterns to surfaces adjacent the light fixtures disclosed.

### SUMMARY OF ASPECTS OF THE INVENTION

The present invention provides novel light fixture having housings that enhance not only the appearance of the fixture but may also display strikingly distinct light patterns on adjacent surfaces. For example, one embodiment of the present invention is a light fixture including or comprising: a light source; and a housing mounted about the light source, the housing including or comprising: an at least translucent body, for example, a transparent glass body, having a first end adapted to retain the light source and a second end opposite the first end; an outer surface of the body having a plurality of facets adapted to refract at least some light emitted by the light source; and an opening in the second end of the body having an internal dimension less than about 60% of an external dimension of the body at the second end. In one aspect, the internal dimension of the opening in the second end is less than about 50% or less than 40% of the external dimension of the body at the second end. In another aspect, the plurality of facets is further adapted to reflect at least some of the light emitted by the light source. The light source may be one or more of incandescent lights, fluorescent lights, or a semi-conductor-based lights, for example, one or more light-emitting diodes (LEDs). IN one aspect, the light fixture produces a substantially uniform light pattern, for example, on a surface adjacent the light fixture.

Another embodiment of the invention is a method of displaying light including or comprising: positioning a light source in a housing including or comprising: an at least translucent body having a first end adapted to retain the light source and a second end opposite the first end; an outer surface of the body having a plurality of facets; and an opening in the second end of the body having an internal dimension less than about 60% of an external dimension of the body at the second end; and refracting at least some light emitted by the light source with at least some of the plurality of facets. In one aspect, the method further includes reflecting at least some of the light emitted by the light source from at least some of the plurality of facets.

A further embodiment of the invention is a light fixture including or comprising: a light source; and a hemispherical glass housing mounted about the light source, the hemispherical glass housing including or comprising: a body having a first end adapted to retain the light source and a second end opposite the first end; an outer surface of the body having a plurality of facets adapted to refract at least some light emitted by the light source; an opening in the second end of the body having an internal dimension less than about a 60% of an external dimension of the body at the second end; a radius of curvature R of the body; and a height H of the body ranging from about 0.75 R to about 1.25 R. In one aspect, the height H may substantially be equal to the radius R. The light source may be one or more incandescent light sources, fluorescent light sources, or a semi-conductor-based light sources, such as, LEDs.

A still further embodiment of the invention is a light fixture housing including or comprising: an at least translucent body, for example, a substantially transparent glass body, including or comprising: a first end adapted to retain a light source and a second end opposite the first end; an outer surface having a plurality of facets adapted to refract at least some light emitted by the light source; and an opening in the second end having an internal dimension less than about 60% of an external dimension of the body at the second end. Again, the internal dimension of the opening may be less than about 50% of the external dimension of the body, or less than about 40% of the external dimension. The plurality of facets may be further adapted to reflect at least some of the light emitted by the light source. In one aspect, the opening in the second end may be a cylindrical bore, for example, a circular cylindrical bore and a polygonal cylindrical bore. In another aspect of the invention, the height of the body H may be a function of the radius of curvature R of the body, for example, the height H may range from about 0.10 R to about 1.90 R. In one aspect, the height H may be substantially equal to the radius R.

Other embodiments of the invention include the light fixtures, light fixture housings, or light fixture housing bodies as shown and described.

Details of these aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of a ceiling mounted light fixture according to one embodiment of the invention.

FIG. 2 is an enlarged perspective view of the light fixture shown in FIG. 1.

FIG. 3 is a front elevation view of the light fixture shown in FIGS. 1 and 2.

FIG. 4 is a side elevation view of the light fixture shown in FIGS. 1 and 2.

FIG. 5 is a top plan view of the light fixture shown in FIGS. 1 and 2.

FIG. 6 is a bottom view of the light fixture shown in FIGS. 1 and 2.

FIG. 7 is an exploded perspective view of the light fixture shown in FIGS. 1 and 2.

FIG. 8 is a perspective view of a wall mounted light fixture according to another embodiment of the invention.

FIG. 9 is an enlarged perspective view of the light fixture shown in FIG. 8.

FIG. 10 is a side elevation view of the light fixture shown in FIGS. 8 and 9.

FIG. 11 is a front elevation view of the light fixture shown in FIGS. 8 and 9.

FIG. 12 is a cross-section view of the light fixture shown in FIGS. 8 and 9, as viewed along section lines 12-12 in FIG. 11.

FIG. 13 is an exploded perspective view of the light fixture shown in FIGS. 8 and 9.

FIG. 14 is a perspective view of a hanging light fixture according to another embodiment of the invention.

FIG. 15 is an enlarged perspective view of the light fixture shown in FIG. 14.

FIG. 16 is a side elevation view of the light fixture shown in FIGS. 14 and 15.

FIG. 17 is a top plan view of the light fixture shown in FIGS. 14 and 15.

FIG. 18 is a bottom view of the light fixture shown in FIGS. 14 and 15.

FIG. 19 is an exploded perspective view of the light fixture shown in FIGS. 14 and 15.

FIG. 20 is a side elevation view of a further embodiment of the invention having multiple light fixtures shown in FIGS. 14 and 15.

FIG. 21 is a perspective view of a light fixture housing according to another embodiment of the invention.

FIG. 22 is a side elevation view of the light fixture housing shown in FIG. 21.

FIG. 23 is a top plan view of the light fixture housing shown in FIG. 21.

FIG. 24 is a cross-section view of the light fixture housing shown in FIG. 21 as viewed along section lines 24-24 in FIG. 22.

FIG. 25 is a cross-sectional view similar to FIG. 24 illustrating typical dimension of the light fixture housing shown in FIG. 21.

### DETAILED DESCRIPTION OF FIGURES

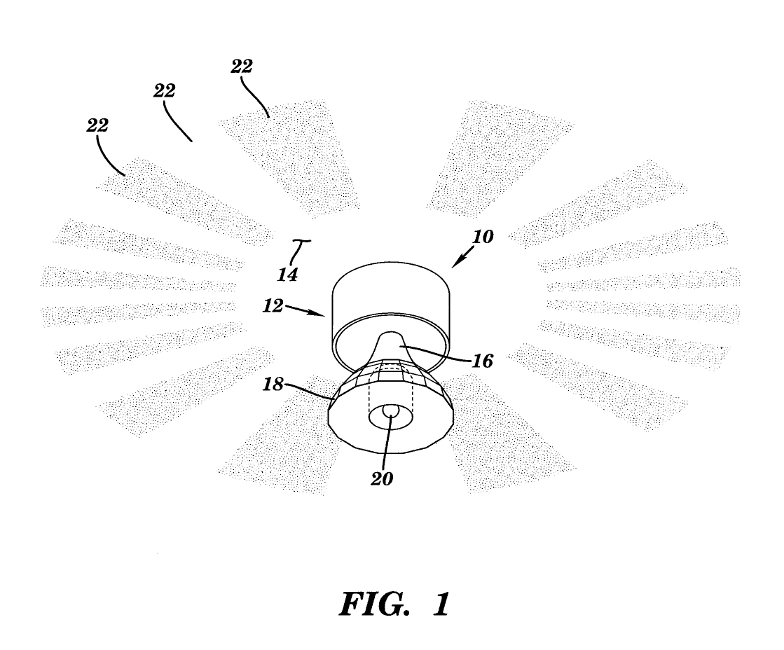

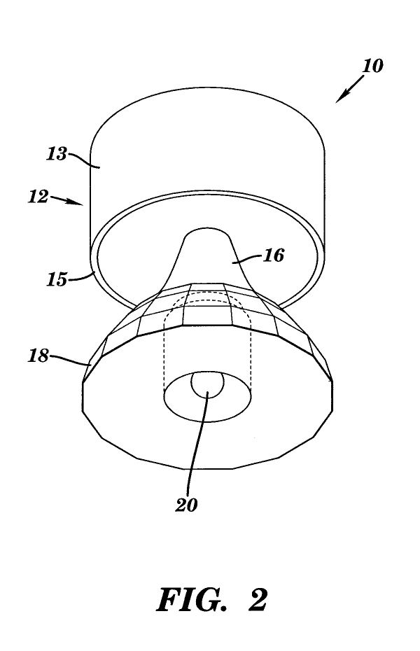

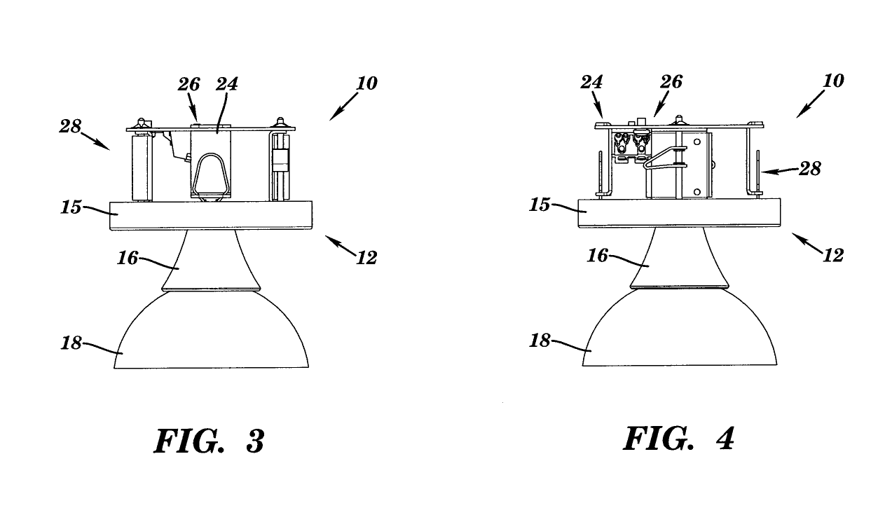

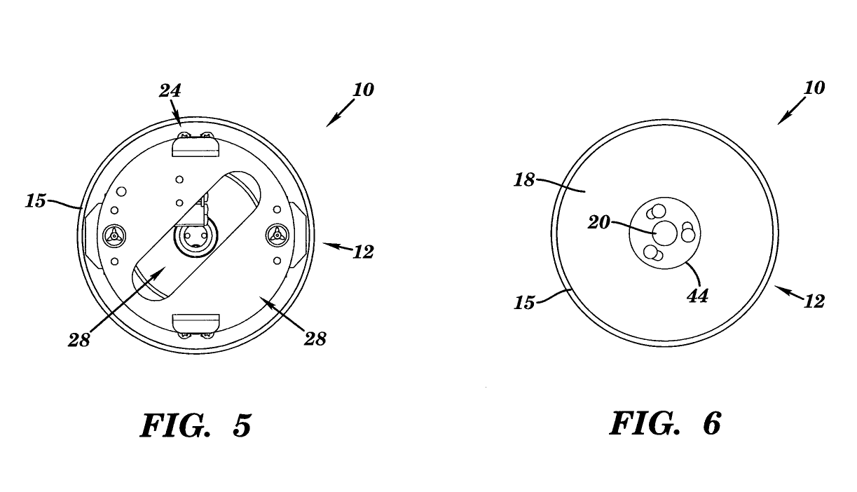

The details and scope of the aspects of the present invention can best be understood upon review of the attached figures and their following descriptions. FIG. 1 is a perspective view of a ceiling mounted light fixture 10 according to one embodiment of the invention. FIG. 2 is an enlarged perspective view of the light fixture 10 shown in FIG. 1. FIG. 3 is a front elevation view of light fixture 10, FIG. 4 is a side elevation view of light fixture 10, FIG. 5 is a top plan view of light fixture 10, and FIG. 6 is a bottom view of the light fixture shown in FIGS. 1 and 2. As shown, light fixture 10 includes a mounting sconce 12 adapted to mount light fixture 10 to an overhead surface 14, for example, to a ceiling or overhang; a neck portion 16 mounted to the mounting sconce 12; a housing 18 mounted to neck portion 16, for example, as described below, housing 18 may comprise a faceted glass crystal; and a light source 20 mounted within housing 18, for example, a halogen-type light. Mounting sconce 12 typically contains mounting hardware, an electrical power interface, controls, and/or electronics, in general, “the electronics,” adapted to power and operate light fixture 10. Mounting sconce 12 may include a cylindrical skirt 13 enclosing the electronics and a base 15. In FIGS. 3 through 5, the cylindrical skirt 13 of sconce 12 is removed to expose the mounting hardware 24, electronics 26, and support structures 28 within mounting sconce 12 and typically mounted to base 15. As is conventional, electronics 26 and mounting sconce 12 are adapted to receive electrical power from the local electrical grid, for example, 120-240 volts AC (VAC).

As shown in FIG. 1, according to aspects of the present invention, housing 18 of light fixture 10 may comprise at least a translucent housing, for example, a transparent housing adapted to produce a distinctive light pattern 22, for example, as will be discussed in more detail below, by means of facets on the outer surface of housing 18. This or similar distinctive light patterns 22 may characterize all the embodiments of the present invention disclosed herein. Aspects of the present invention include this feature of providing a light pattern 22, for example, a uniform pattern, for instance, a radial pattern, of light and dark areas, on a surface, for example, on a ceiling, on a floor, or on any surface, such as, a table. As discussed in detail below, in one aspect, housing 18 may be a glass crystal having a faceted outer surface adapted to refract and/or reflect light from light source 20 to produce light pattern 22, or a similarly distinctive pattern.

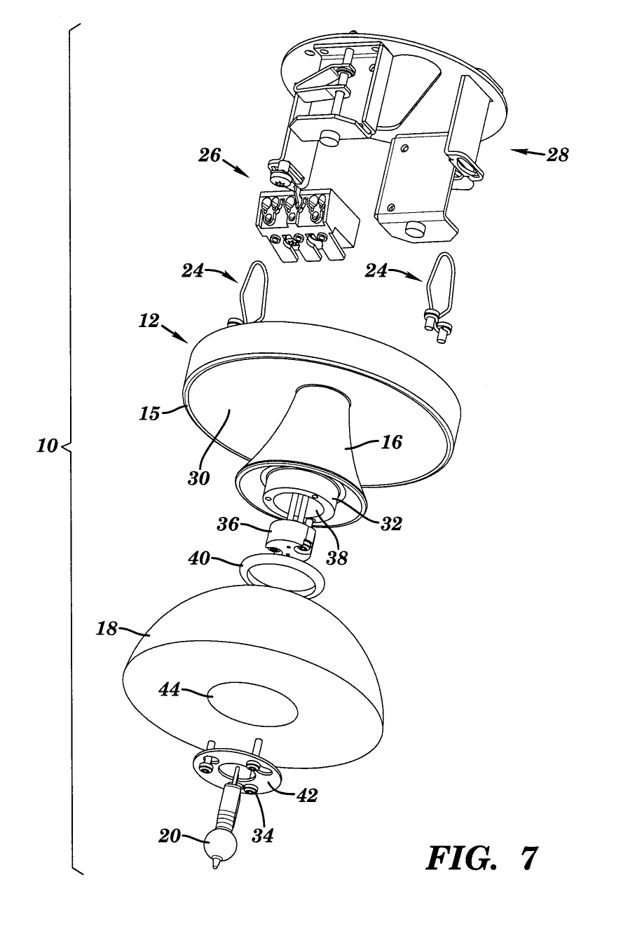

FIG. 7 is an exploded perspective view of the light fixture 10 shown in FIGS. 1 through 6. As shown most clearly in FIG. 7, base 15 of mounting sconce 12 may typically comprise a concave dome-shaped bottom 30 to which neck portion 16 may be mounted, for example, detachably mounted, though base 15 and neck portion 16 may be fabricated as a single integral component. In one aspect, bottom 30 may take any desired shape, for example, bottom 30 may be convex or substantially flat. As shown in FIG. 7, neck portion 16 may be generally conical in shape, for example, a truncated conical shape as shown, though in some aspects portion 16 may be cylindrical, for example, circular cylindrical or polygonal cylindrical. In one aspect, neck potion 16 may comprise a rod or shaft. As also shown in FIG. 7, neck portion 16 may be at least partially hollow, for example, to minimize the amount of material and weight of neck portion 16 and to receive other components and electrical wiring.

Neck portion 16 may also be adapted to receive housing 18, for example, the geometry of neck portion 16 may be shaped to receive the shape of housing 18. For instance, as shown in FIG. 7, the bottom of neck portion 16 may be generally circular to adapt to the shape of housing 18, for example, a hemispherical shape as shown. Neck portion 16 may also include a mounting flange 32 positioned and adapted to receive mechanical fasteners 34 that mount housing 18, for example, with crews or bolts, as shown in FIG. 7.

Typically, light fixture 10 will also include one or more lamp holders 36 adapted to receive one or more light sources 20, for example, a lamp holder provided by BJB, or its equivalent. Neck portion 16 typically includes one or more cavities 38 sized and positioned to receive lamp holder 36 and any electrical wiring or leads associated with lamp holder 36. As is conventional, light fixture 10 is designed to accommodate electrical wires or connections between lamp holder 36 and electronics 26 in mounting sconce 12.

As also shown in FIG. 7, light fixture 10 may include a flexible interface, for example, an elastomeric o-ring 40, positioned between neck portion 16 and housing 18. The flexible interface, such as, o-ring 40, provides a flexible, pliable, or cushioning medium between neck portion 16 and housing 18 to enhance the support of housing 18 and to accommodate any variations in the mating surfaces between neck portion 16 and housing 18. As discussed in further detail below, housing 18 may comprise a glass crystal having a faceted outer surface; a flexible medium, such as, o-ring 40, can provide more secure engagement between neck portion 16 and a faceted surface of housing 18.

Housing 18 may be secured to neck portion 16 by means of mechanical fasteners 34. As shown in FIG. 7, a mounting plate 42, for example, a circular ring-shaped mounting plate having through holes, may be used to engage housing 18, for example, within bore 44 of housing 18, to secure housing 18 to neck portion 16. Bore 44 is positioned and sized to emit light from light source 20. In one aspect, fasteners 34 may pass through the through holes in mounting plate 42 and threadably engage mounting flange 32 in neck portion 16. Light source 20 is typically inserted through bore 44, through mounting plate 42 and into lamp holder 36 in a conventional fashion.

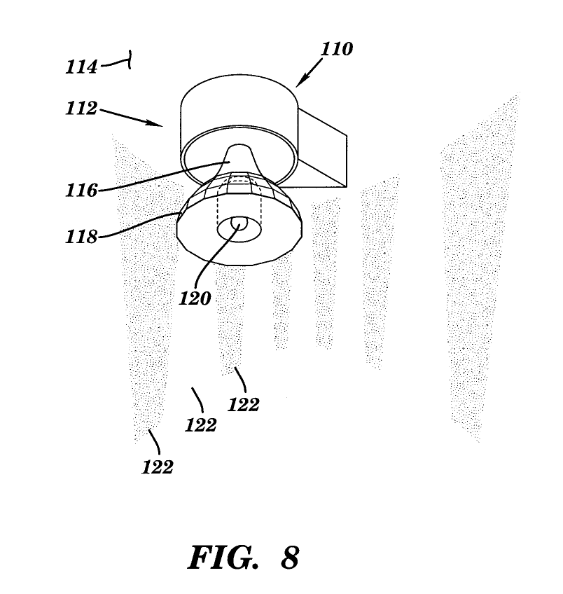

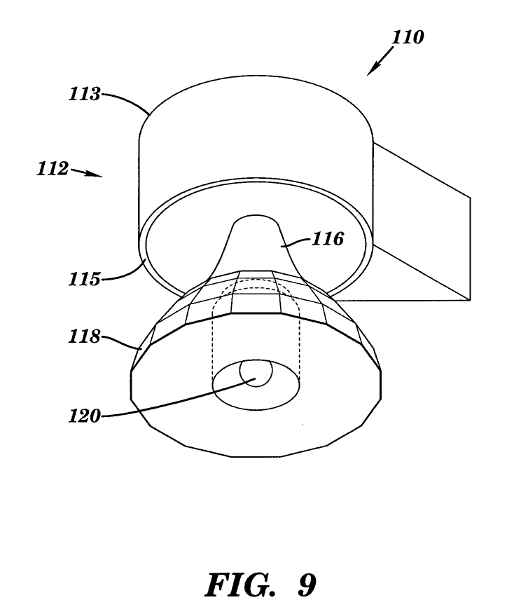

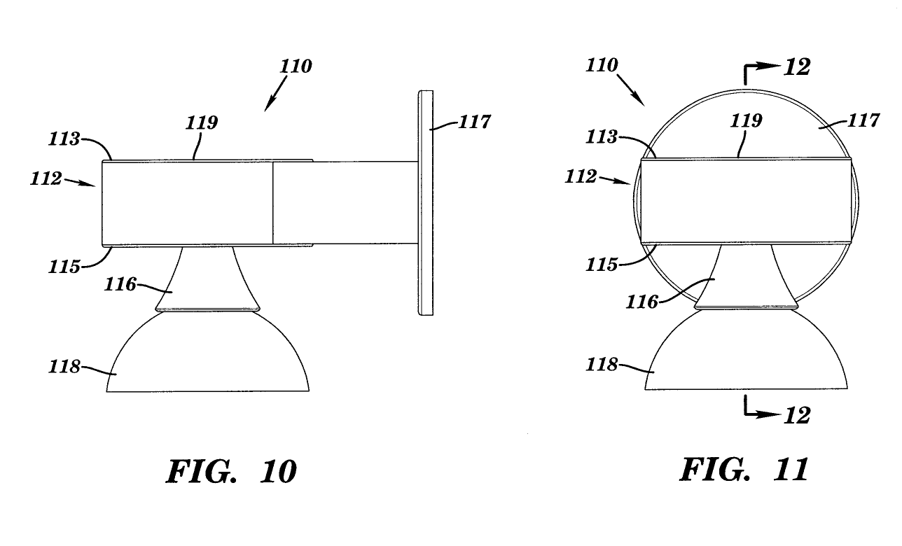

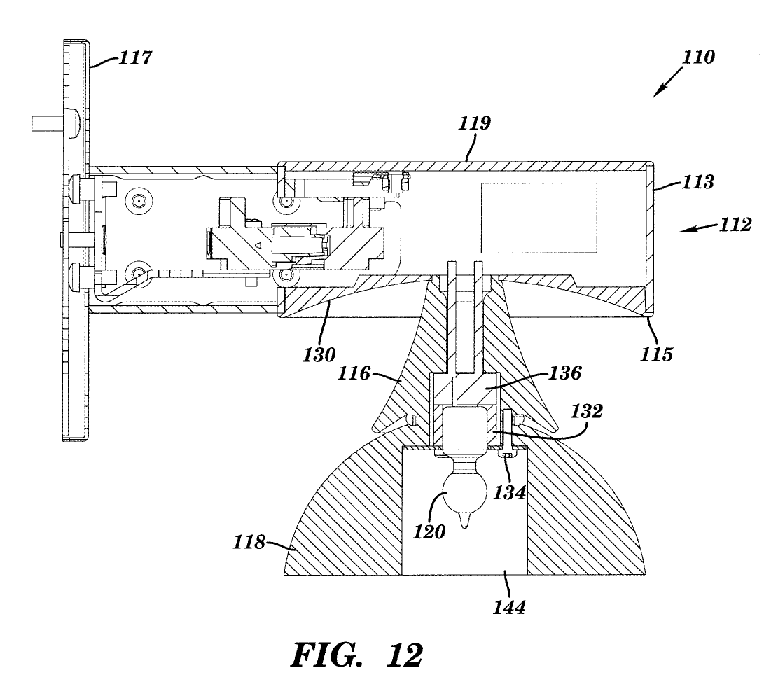

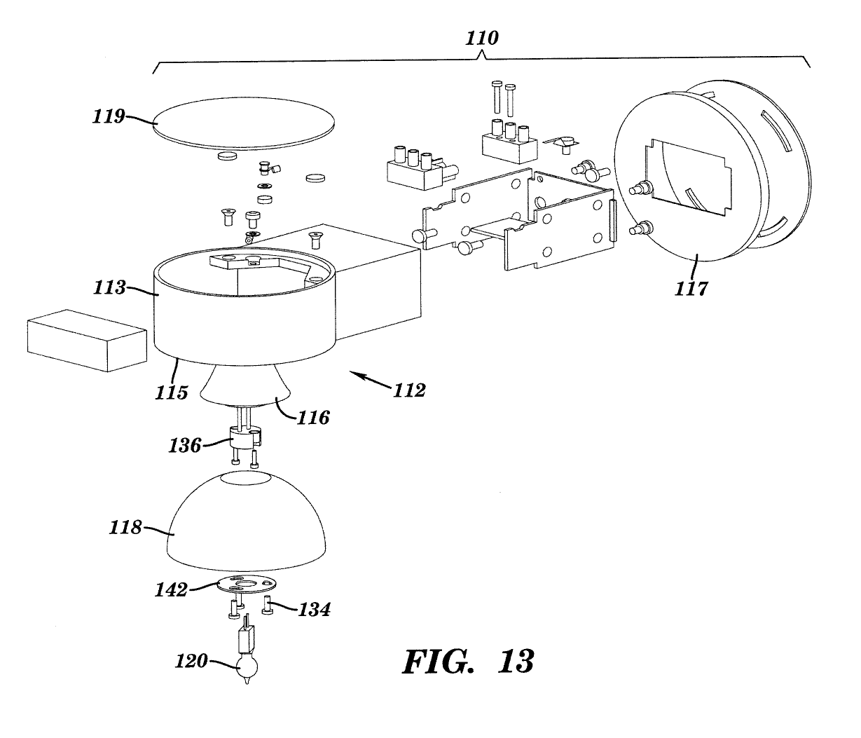

FIG. 8 is a perspective view of a wall mounted light fixture 110 according to another embodiment of the invention. FIG. 9 is an enlarged perspective view of light fixture 110 shown in FIG. 8. FIG. 10 is a side elevation view and FIG. 11 is a front elevation view of light fixture 110 shown in FIGS. 8 and 9. FIG. 12 is a cross-section view of the light fixture 110 shown in FIGS. 8 and 9, as viewed along section lines 12-12 in FIG. 11. FIG. 13 is an exploded perspective view of the light fixture 110 shown in FIGS. 8 and 9. It will be apparent that many of the features of light fixture 110 may be similar, if not identical, to the features of light fixture 10 shown and described with respect to FIGS. 1-7, though adapted for a wall-mounted fixture.

As shown most clearly in FIGS. 10 and 11, light fixture 110 includes a mounting sconce 112 having a mounting plate 117 adapted to mount light fixture 110 to a substantially vertical surface 114 (FIG. 8), for example, a wall; a neck portion 116 mounted to the mounting sconce 112; a housing 118 mounted to neck portion 116, for example, again, housing 118 may comprise a faceted glass crystal; and a light source 120 mounted within housing 118, for example, a halogen-type light. Mounting sconce 112 typically contains mounting hardware, an electrical power interface, controls, and/or electronics, in general, “the electronics” adapted to power and operate light fixture 110. Mounting sconce 112 may include a cylindered skirt 113, a base 115, and a top 119. Mounting sconce 112 may enclose mounting hardware, electronics, and support structures within mounting sconce 112 which may be mounted to base 115. As is conventional, the electronics and mounting sconce 112 are adapted to receive electrical power from the local electrical grid, for example, 120-240 VAC.

As shown in FIG. 8, according to aspects of the present invention, housing 118 of light fixture 110 may comprise at least a translucent housing, for example, a transparent housing adapted to produce a distinctive light pattern 122, which may characterize aspects of the invention disclosed herein.

As shown most clearly in FIG. 12, base 115 of mounting sconce 112 may typically comprise a concave dome-shaped bottom 130 to which neck portion 116 may be mounted, for example, detachably mounted, though sconce 112 and neck portion 116 may be fabricated as a single integral component. In one aspect, bottom 130 may take any desired shape, for example, bottom 130 may be convex or substantially flat. As shown in FIG. 12, neck portion 116 may be generally conical in shape, for example, a truncated conical shape as shown, though in some aspects portion 116 may be cylindrical, for example, circular cylindrical or polygonal cylindrical. In one aspect, neck portion 116 may comprise a rod or shaft. As also shown in FIG. 12, neck portion 116 may be at least partially hollow, for example, to minimize the amount of material and weight of neck portion 116 and to accommodate components and electrical wiring.

As discussed above with respect to light fixture 10, neck portion 116 of light fixture 110 may also be adapted to receive housing 118, for example, having a generally circular shape to adapt to the shape of housing 118, for example, a hemispherical shape as shown, and include a mounting flange 132 positioned and adapted to receive mechanical fasteners 134 that mount housing 118. Also, light fixture 110 will also include one or more lamp holders 136 adapted to receive one or more light sources 120, and neck portion 116 typically includes one or more cavities 138 sized and positioned to receive lamp holder 136 and any electrical wiring or leads associated with lamp holder 136. Though not shown in FIG. 12 or 13, light fixture 110 may include a flexible interface, for example, an elastomeric o-ring, positioned between neck portion 116 and housing 118 to provide more secure engagement between neck portion 116 and a faceted surface of housing 118. A mounting plate 142 may be use to engage housing 118, for example, within a bore 144 of housing 118, to secure housing 118 to neck portion 116.

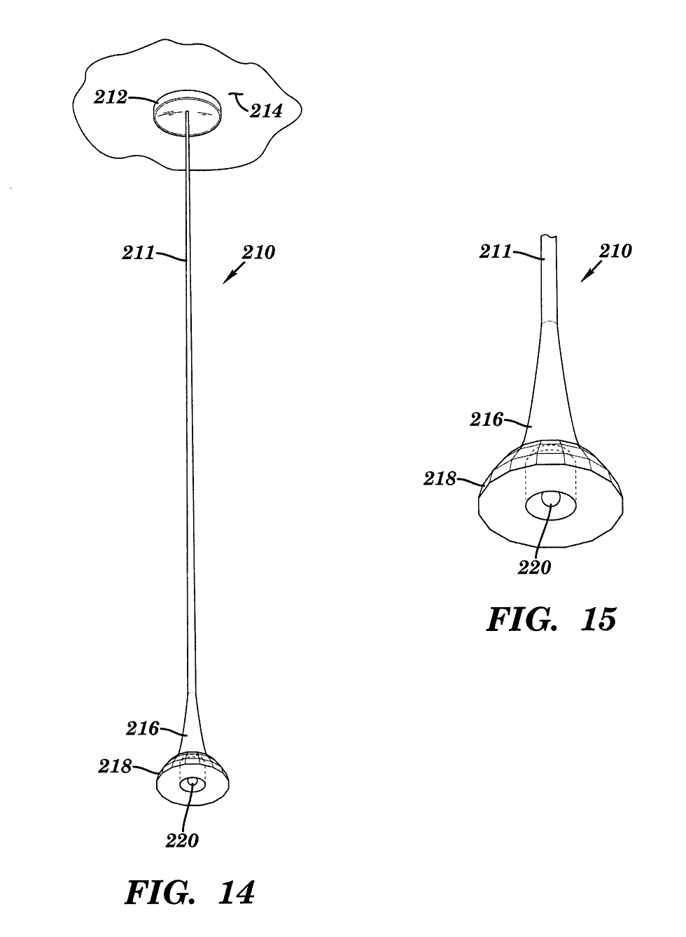

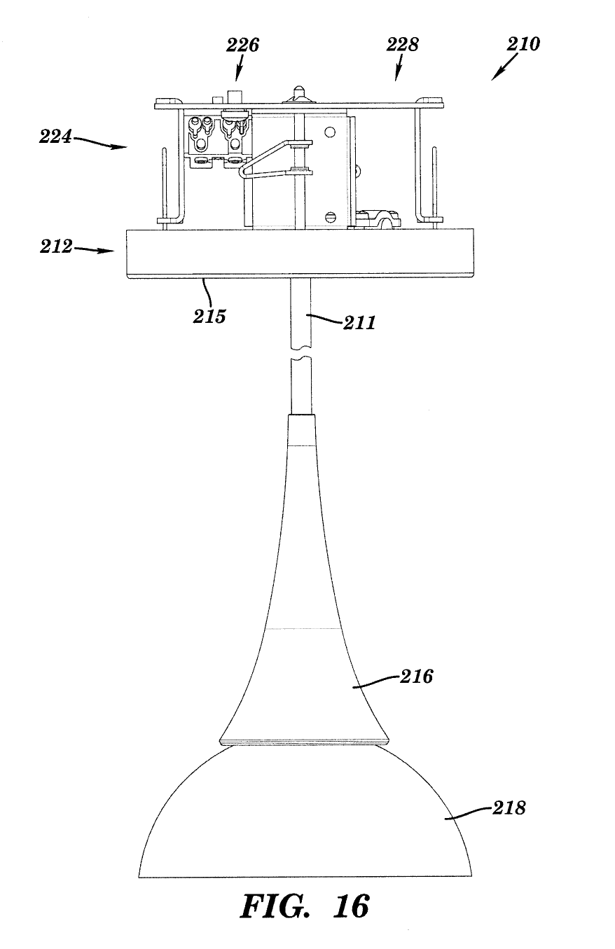

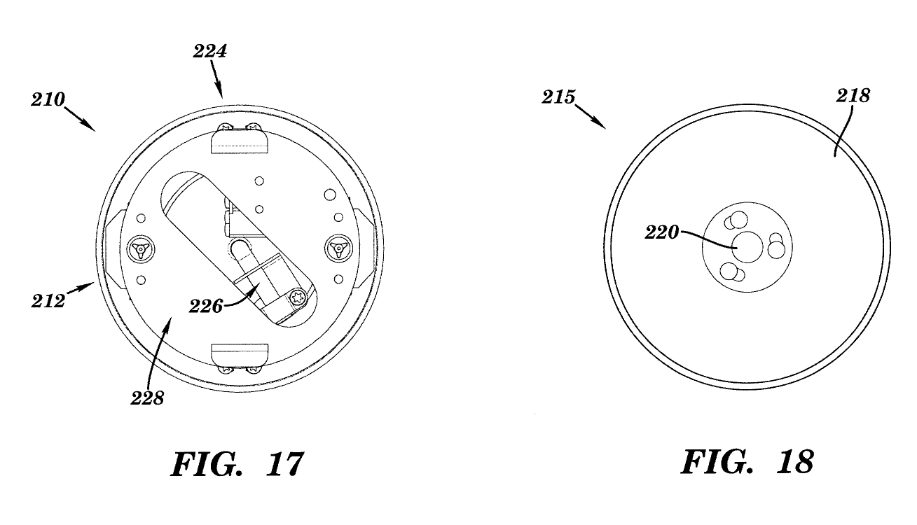

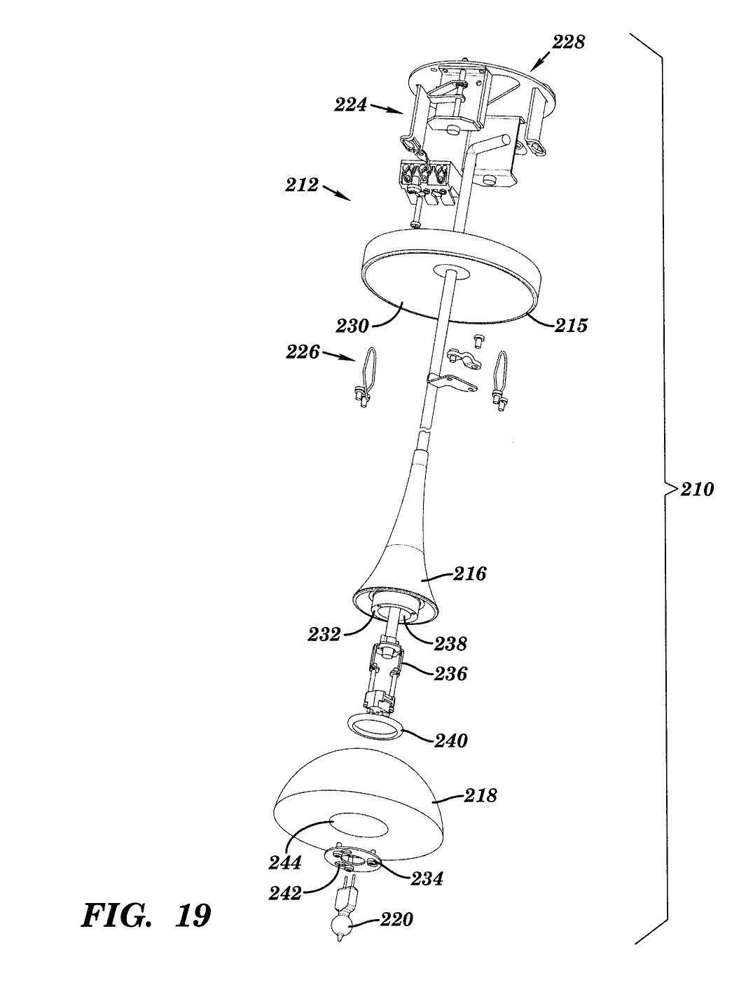

FIG. 14 is a perspective view of a hanging light fixture 210 according to another embodiment of the invention. FIG. 15 is an enlarged perspective view of light fixture 210 shown in FIG. 14. FIG. 16 is a side elevation view, FIG. 17 is a top plan view, FIG. 18 is a bottom view, and FIG. 19 is an exploded perspective view of light fixture 210 shown in FIGS. 14 and 15. Again, it will be apparent that many of the features of light fixture 210 may be similar, if not identical, to the features of light fixtures 10 and 110 shown and described with respect to FIGS. 1-13, though adapted for a hanging fixture.

As shown in FIGS. 14 through 19, light fixture 210 includes a mounting sconce 212 adapted to mount light fixture 210 to a substantially horizontal surface 214, for example, to a ceiling or overhand; an elongated hollow rod 211 extending from mounting sconce 212; a neck portion 216 mounted to elongated rod 211; a housing 218 mounted to neck portion 216, for example, again, housing 218 may comprise a faceted glass crystal; and a light source 220 mounted within housing 218, for example, a halogen-type light. Mounting sconce 212 typically contains mounting hardware, an electrical power interface, controls, and/or electronics, in general, “the electronics” adapted to power and operate light fixture 210. Mounting sconce 212 may include a cylindrical skirt enclosing the mounting hardware, electronics, and support structures within mounting sconce 212 and mounted on a base 215. In FIGS. 16 through 19, the cylindrical skirt of sconce 212 is removed to expose the mounting hardware 224, electronics 226, and support structures 228 within mounting sconce 212 and typically mounted to base 215. As is conventional, the electronics 226 and sconce 212 are adapted to receive electrical power from the local electrical grid, for example, 120-240 VAC.

According to aspects of the present invention, housing 218 of light fixture 210 may comprise at least a translucent housing, for example, a transparent housing adapted to produce a distinctive light pattern (not shown) which may characterize aspects of the invention disclosed herein, for example, see the light pattern 22 and 122 shown in FIGS. 1 and 8, respectively.

As shown most clearly in FIG. 19, base 215 of mounting sconce 212 may typically comprise a concave dome-shaped bottom 230 to which extended rod 211 may be mounted, for example, detachably mounted. In one aspect, bottom 230 may take any desired shape, for example, bottom 230 may be convex or substantially flat. Extended rod 211 is typically hollow and provides a conduit for electrical wiring between mounting sconce 212 and light source 220. As shown in FIG. 19, neck portion 216 mounted to extended rod 211 may be generally conical in shape, for example, a truncated conical shape as shown, though in some aspects portion 216 may be cylindrical, for example, circular cylindrical or polygonal cylindrical. In one aspect, neck potion 216 may comprise an extension of rod 211, or neck portion 216 may be omitted. As also shown in FIG. 19, neck portion 216 may be at least partially hollow, for example, to minimize the amount of material and weight of neck portion 216, and to accommodate component and electrical wiring.

As discussed above with respect to light fixtures 10 and 110, neck portion 216 of light fixture 210 may also be adapted to receive housing 218, for example, having a generally circular shape to adapt to the shape of housing 218, for example, a hemispherical shape as shown and include a mounting flange 232 positioned and adapted to receive mechanical fasteners 234 that mount housing 218. Also, light fixture 210 will include one or more lamp holders 236 adapted to receive one or more light sources 220, and neck portion 216 typically includes one or more cavities 238 sized and positioned to receive lamp holder 236 and any electrical wiring or leads associated with lamp holder 236. As also shown in FIG. 19, light fixture 210 may include a flexible interface 240, for example, an elastomeric o-ring, positioned between neck portion 216 and housing 218 to provide more secure engagement between neck portion 216 and a faceted surface of housing 218. A mounting plate 242 may be use to engage housing 218, for example, within a bore 244 of housing 218, to secure housing 218 to neck portion 216.

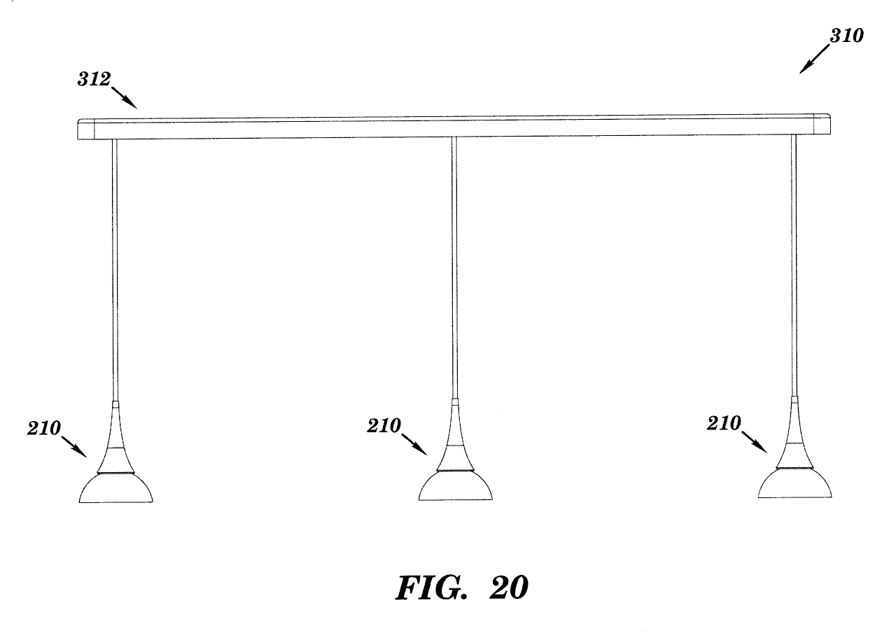

FIG. 20 is a side elevation view of a further embodiment of the invention comprising a light fixture 310 having multiple light fixtures 210 shown in FIGS. 14 through 19. As shown, light fixture 310 may include a mounting sconce 312, for example, an elongated mounting sconce, adapted to mount to a horizontal surface, for example, a ceiling or overhang. As is typically, mounting sconce 312 typically includes the mounting hardware, electronics, and structural hardware to mount, support, and power light fixture 310. Again, according to aspects of the present invention, light fixture 310 may be adapted to produce a distinctive light pattern (not shown) which may characterize aspects of the invention disclosed herein.

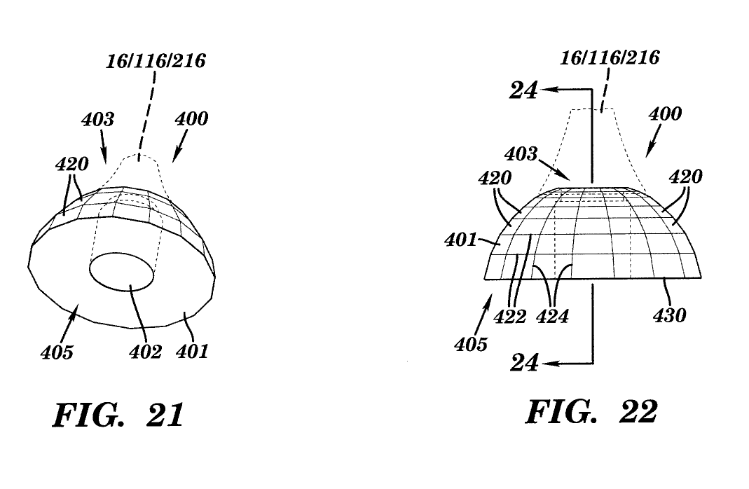

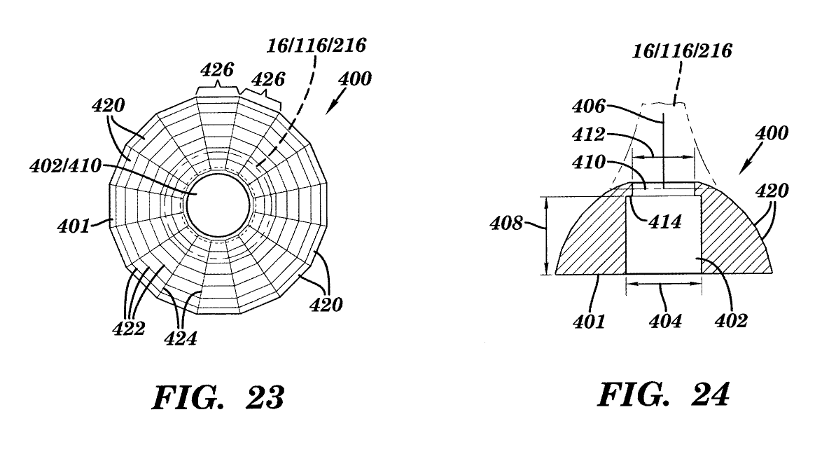

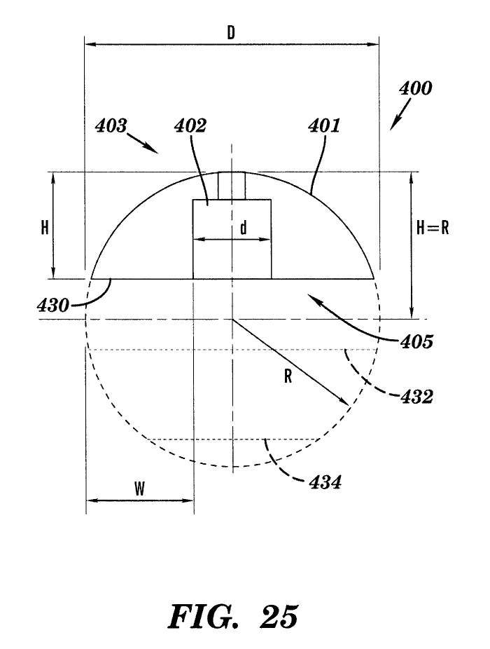

FIG. 21 is a perspective view of a light fixture housing 400 according to another embodiment of the invention. As described above, light fixture housing 400 may comprise a crystal glass housing, or simply, a “crystal,” and be used for any one or more of the housings disclosed herein, for example, for housing 18, 118, or 218 described above. FIG. 22 is a side elevation view of the light fixture housing 400, FIG. 23 is a top plan view of light fixture housing 400, and FIG. 24 is a cross-section view of the light fixture housing 400 shown in FIG. 21 as viewed along section lines 24-24 in FIG. 22. Housing 400 comprises a body 401.

As shown, in one aspect, body 401 of housing 400 may be hemispherical in shape, that is, body 401 may have a shape approximate the shape of half of sphere; though, as discussed further below, body 401 may be many different types of three-dimensional, or volumetric, shapes while providing the desired appearance and optical effect. For example, body 401 may be circular cylindrical in shape, polygonal cylindrical in shape, or spherical in shape. In one aspect, body 401 may display axial symmetry, that is, be axi-symmetric, for example, comprise a volume that can be generated by the rotation of area about an axis. Body 401 comprises a first end 403, for example, adapted to retain a light source, and a second end 405 opposite first end 403.

According to aspects of the invention, body 401 includes a central through hole or bore 402 having a lateral dimension 404, such as, a width or diameter. As described above, bore 402 is typically adapted to receive a light source (not shown), for example, light source 20, 120, or 220 disclosed above. Bore 402 may be circular or non-circular, for example, bore 402 may be elliptical or polygonal, for, example, triangular, square, rectangular, hexagonal, or octagonal, among other polygonal shapes. However, in the aspect of the invention shown in FIGS. 21-24, bore 402 is generally circular in shape. Bore 402 includes a centerline 406 and a depth 408. In one aspect, centerline 406 of bore 402 may be generally coincident with the axis of body 401 (also indicated by line 406 in FIG. 24). However, in one aspect of the invention the centerline 406 of bore 402 may not be coincident with axis of body 401, but may be oriented at an angle to the axis of body 401. Bore 402 may extend through body 401 with a lateral dimension 404 through body 401; however, as shown in FIG. 24, in one aspect, bore 402 may be limited to a depth 408 that does not penetrate completely through body 401. As shown, body 401 may have a second bore 410 having a lateral width 412, for example, a width or diameter, and second bore 410 may be generally co-axial with bore 402. Bore 402 and bore 410 may define an edge or lip 414, for example, an annular edge or lip, positioned and adapted to engage mounting hardware, for example, rings 42, 142, and 242 described above.

According to aspects of the present invention, body 401 of housing 400 includes a plurality of facets 420 on the outer surface of body 401. That is, the outer surface of body 401 includes a plurality of surfaces 420, typically, planar, arranged on the surface of body 401 that function to refract and/or reflect light emitted by a light source positioned in bore 402. According to aspects of the present invention, any number of facets 420 of relatively constant or varying shapes and arrangements may be provided on the surface of body 401, for example, depending upon the shape of body 401. As shown in FIGS. 22 and 23, in one aspect, facets 420 may be generally rectangular, specifically, trapezoidal, facets arranged in a generally radially pattern where the facets 420 are delimited by the edges of rings 422 and radial edges 424. As shown in FIG. 23, radial edges 424 may define 16 sectors 426 having 7 facets per sector. However, according to aspects of the invention the number of sectors 426 and the number of facets 420 per sector may vary. For example, the number of sectors 426 of facets 420 on body 401 may vary from 3 to 1000, depending upon the size of body 401; however, the number of sectors 426 may typically be between 10 and 30, for example, the 16 sectors 426 shown in FIG. 23. The number of facets 420 per sector 426 on body 401 may vary from 3 to 1000, depending upon the size of body 401; however, the number of facets 420 per sector 426 may typically be between 4 and 15, for example, the 7 facets 420 per sector 426 shown in FIG. 23.

It will be apparent to those of skill in the art that the number, shape, and size of facets 420; the number, shape, and size of sectors 426; and the shape and size of body 401 may vary broadly depending upon the size and shape of body 401 of housing 400.

FIG. 25 is a cross-sectional view similar to FIG. 24 illustrating the typical dimensions that may be used to define the size and shape of the body 401 of housing 400 according to aspects of the invention. As shown in FIG. 25, the size and shape of body 401 may be defined by radius of curvature R, height H, and lateral dimensions d and D. Radius R may typically be the radius of a hemispherical, spherical, or circular cylindrical body or half the width of a polygonal cylindrical body 401. Height H may typically be the height of body 401 from the top of body 401, for example, from the apex of the projection of the surface of radius R, to the base 430 of body 401. Dimension D may be the external dimension or lateral dimension of body 401, for example, an external dimension, such as, a diameter of a hemispherical, spherical, or circular cylindrical body or a width of a polygonal cylindrical body 401. Dimension d may be the lateral dimension of bore 402, for example, an internal dimension of bore 402, such as, a diameter or width. For the sake of brevity, lateral dimensions d and D will be referred to as diameters in the following discussion, though lateral dimensions d and D may be a width of, for example, a rectangular opening.

As shown in FIG. 25, though in one aspect of the invention, body 401 may comprise a substantially hemispherical shape, for example, where height H is substantially equal to radius R, body 401 may have a height H greater than or less than radius R. For example, as shown in FIG. 25, height H is less than radius R. However, body 401 may have a height H greater than R as indicated by bases 432 and 434 shown by phantom lines in FIG. 25. In one aspect, the height H may a function of radius R, for example, height H may range from about 0.10 R to about 1.90 R. In one aspect, height H may range from about 0.50 R to about 1.50 R; or height H may range from about 0.75 R to about 1.25 R. Again, in one aspect, height H is substantially equal to the radius R. Though not shown for all bases in FIG. 25, according to one aspect of the invention, the bore 402 typically extends to base 430, 432, or 434 regardless of the height H.

Though according to aspect of the invention there may be no numerical relationship between diameter d and diameter D, in one aspect, diameter d may comprise a percentage of diameter D. For example, the inventors have found that having a diameter d less than diameter D, for example, where the width W of the body 401 of housing 400 between the diameter D of body 401 and the diameter d of bore 402 is greater than the diameter d, provides a more appealing display of, for example, a light fixture and a more appealing light pattern produced by a light fixture having a housing 400. For example, in one aspect of the invention, the dimension d may be less than about 60% of diameter D. In another aspect, dimension d may be less than about 50% of diameter D, or less than about 40% of diameter D. Though the relationships between diameter d and diameter D are expressed above in round numbers, it is to be understood that according to aspects of the invention, diameter d may be less than any intermediate percentage, for example, 55%, 54%, 53% . . . 45%, 35% , 25%, 15% of diameter D, and reside within the purview of the present invention.

Body 401 of housing 400 may have a radius R ranging from about 5 mm to about 5000 mm, but typically ranges between about 25 mm and about 75 mm, for example, about 50 mm. The height H may range from about 5 mm to about 5000 mm, but typically ranges between about 25 mm and about 75 mm, for example, about 40 mm. The diameter D may range from about 5 mm to about 5000 mm, but typically ranges between about 50 mm and about 150 mm, for example, about 100 mm. The diameter d may range from about 5 mm to about 3000 mm, but typically ranges between about 25 mm and about 75 mm, for example, about 34 mm.

According to aspects of the invention body 401 may be made from any appropriate material. However, according to one aspect of the invention, body 401 may be at least translucent, but typically is substantially transparent, for example, to allow the desired transmission and refraction and/or reflection of light from the light source positioned in body 401. Body 401 may have a tint or color, for example, red or blue, but may typically be substantially clear. In one aspect, body 401 may be made of plastic. In another aspect, body 401 may be made of glass, for example, high quality glass, such as, first quality, lead-free glass crystal provided by D. Swarovski & Co. of Wattens, Austria, though other types of glass may be used. According to one aspect of the invention body 401 may comprise “crystal” or a “glass crystal” as known in the art.

Aspects of the present invention provide light fixtures, methods of displaying light, and light fixture housings or crystals that provide enhanced customer appeal, for example, both in the appearance of the light fixture and the appearance of the light images produced on adjacent surfaces. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A light fixture comprising:
a light source; and
a housing mounted about the light source, the housing comprising:
an at least translucent body having a first end adapted to retain the light source and a second end opposite the first end;
an outer surface of the body having a plurality of facets adapted to refract at least some light emitted by the light source; and
an opening in the second end of the body having an internal dimension less than about 60% of an external dimension of the body at the second end.

2. The light fixture as recited in claim 1, wherein the internal dimension of the opening in the second end is less than about 50% of the external dimension of the body at the second end.

3. The light fixture as recited in claim 2, wherein the internal dimension of the opening in the second end is less than about 40% of the external dimension of the body at the second end.

4. The light fixture as recited in claim 1, wherein the plurality of facets are further adapted to reflect at least some of the light emitted by the light source.

5. The light fixture as recited in claim 1, wherein the opening in the second end comprises a cylindrical bore.

6. The light fixture as recited in claim 5, wherein the opening in the second end comprises one of a circular cylindrical bore and a polygonal cylindrical bore.

7. The light fixture as recited in claim 1, wherein the at least translucent body comprises a substantially transparent housing.

8. The light fixture as recited in claim 7, wherein the substantially transparent body comprises a glass body.

9. The light fixture as recited in claim 1, wherein the body comprises an axi-symmetric body.

10. The light fixture as recited in claim 1, wherein the housing comprises at least one of a circular cylindrical housing, a polygonal cylindrical housing, a hemispherical housing, and a spherical housing.

11. The light fixture as recited in claim 1, wherein the housing comprises a hemispherical housing.

12. The light fixture as recited in claim 11, wherein the hemispherical housing comprises a hemispherical housing having a radius of curvature R, and a height H ranging from about 0.10 R to about 1.90 R.

13. The light fixture as recited in claim 12, wherein the height H ranges from about 0.50 R to about 1.50 R.

14. The light fixture as recited in claim 13, wherein the height H ranges from about 0.75 R to about 1.25 R.

15. The light fixture as recited in claim 14, wherein the height H is substantially equal to the radius R.

16. The light fixture as recited in claim 1, wherein the light source comprise one or more of an incandescent light source, a fluorescent light source, or a semi-conductor-based light source.

17. The light fixture as recited in claim 16, wherein the semi-conductor-based light source comprises one or more light-emitting diodes (LEDs).

18. The light fixture as recited in claim 1, wherein the light fixture produces a substantially uniform light pattern.

19. The light fixture as recited in claim 18, wherein the substantially uniform light pattern is produced on a surface adjacent the light fixture.

20. The light fixture as recited in claim 18, wherein the substantially uniform light pattern is produced on a surface above or below the light fixture.

21. A method of displaying light comprising:
positioning a light source in a housing comprising:
an at least translucent body having a first end adapted to retain the light source and a second end opposite the first end;
an outer surface of the body having a plurality of facets; and
an opening in the second end of the body having an internal dimension less than about 60% of an external dimension of the body at the second end; and;
refracting at least some light emitted by the light source with at least some of the plurality of facets.

22. The method as recited in claim 21, further comprising reflecting at least some of the light emitted by the light source from at least some of the plurality of facets.

23. The method as recited in claim 21, wherein the at least translucent housing comprises as substantially transparent housing.

24. The method as recited in claim 23, wherein the substantially transparent housing comprises a glass housing.

25. The method as recited in claim 21, wherein the housing comprises at least one of a circular cylindrical housing, a polygonal cylindrical housing, a hemispherical housing, and a spherical housing.

26. The method as recited in claim 25, wherein the housing comprises a hemispherical housing.

27. The method as recited in claim 26, wherein the hemispherical housing comprises a hemispherical housing having a radius of curvature R, and a height H ranging from about 0.10 R to about 1.90 R.

28. The method as recited in claim 27, wherein the height H ranges from about 0.50 R to about 1.50 R.

29. The method as recited in claim 28, wherein the height H ranges from about 0.75 R to about 1.25 R.

30. The method as recited in claim 29, wherein the height H is substantially equal to the radius R.

31. A light fixture comprising:
a light source; and
a hemispherical glass housing mounted about the light source, the hemispherical glass housing comprising:
a body having a first end adapted to retain the light source and a second end opposite the first end;
an outer surface of the body having a plurality of facets adapted to refract at least some light emitted by the light source;
an opening in the second end of the body having an internal dimension less than about a 60% of an external dimension of the body at the second end;
a radius of curvature R of the body; and
a height H of the body ranging from about 0.75 R to about 1.25 R.

32. The light fixture as recited in claim 31, wherein the height H is substantially equal to the radius R.

33. The light fixture as recited in claim 31, wherein the light source comprise one or more of an incandescent light source, a fluorescent light source, and a semi-conductor-based light source.

34. A light fixture housing comprising:
an at least translucent body comprising:
a first end adapted to retain a light source and a second end opposite the first end;
an outer surface having a plurality of facets adapted to refract at least some light emitted by the light source; and
an opening in the second end having an internal dimension less than about 60% of an external dimension of the body at the second end.

35. The light fixture housing as recited in claim 34, wherein the internal dimension of the opening in the second end is less than about 50% of the external dimension of the body at the second end.

36. The light fixture housing as recited in claim 35, wherein the internal dimension of the opening in the second end is less than about 40% of the external dimension of the body at the second end.

37. The light fixture housing as recited in claim 34, wherein the plurality of facets are further adapted to reflect at least some of the light emitted by the light source.

38. The light fixture housing as recited in claim 34, wherein the opening in the second end comprises a cylindrical bore.

39. The light fixture housing as recited in claim 38, wherein the opening in the second end comprises one of a circular cylindrical bore and a polygonal cylindrical bore.

40. The light fixture housing as recited in claim 34, wherein the at least translucent body comprises a substantially transparent body.

41. The light fixture housing as recited in claim 40 wherein the substantially transparent body comprises a glass body.

42. The light fixture housing as recited in claim 34, wherein the housing comprises an axi-symmetric body.

43. The light fixture housing as recited in claim 34, wherein the body comprises at least one of a circular cylindrical body, a polygonal cylindrical body, a hemispherical body, and a spherical body.

44. The light fixture housing as recited in claim 34, wherein the body comprises a hemispherical body.

45. The light fixture housing as recited in claim 44, wherein the hemispherical body comprises a hemispherical body having a radius of curvature R, and a height H ranging from about 0.10 R to about 1.90 R.

46. The light fixture housing as recited in claim 45 wherein the height H ranges from about 0.50 R to about 1.50 R.

47. The light fixture housing as recited in claim 46, wherein the height H ranges from about 0.75 R to about 1.25 R.

48. The light fixture housing as recited in claim 47, wherein the height H is substantially equal to the radius R.
